(19) United States
(12) Patent Application Publication
(10) Pub. No.: US 2026/0338947 A1
(43) Pub. Date: Oct. 29, 2026

(54) UNIFORM MIMO RADAR ANTENNA ARRAY WITH MAIN AND SIDE LOBES

(71) Applicant: MOBILEYE VISION TECHNOLOGIES LTD., Jerusalem (IL)

(72) Inventors: Ofer MARKISH, Ra'anana (IL); Ilia YOFFE, Hod-HaSharon (IL); Moshe TEPLITSKY, Tel-Aviv (IL); Alon COHEN, Modi’in-Maccabim-Reut (IL)

(73) Assignee: MOBILEYE VISION TECHNOLOGIES LTD., Jerusalem (IL)

(21) Appl. No.: 19/471,401

(22) PCT Filed: Apr. 3, 2024
(86) PCT No.: PCT/IB2024/053266

§ 371 Date: Oct. 1, 2025

Related U.S. Application Data
(60) Provisional application No. 63/494,241, filed on Apr. 5, 2023.
(60) Provisional application No. 63/556,787, filed on Feb. 22, 2024.

(51) Int. Cl. G01S 13/931; G01S 7/03; H01Q 1/32; H01Q 21/00

(52) U.S. Cl. CPC G01S 13/931; G01S 7/03; H01Q 1/3233; H01Q 21/00

(57) ABSTRACT

For example, an antenna array may include a plurality of antenna elements arranged according to an array arrangement configured to provide a predefined array factor including a main beam between a first angle and a second angle; a first Side-Lobe (SL) region between the first angle and a third angle including one or more first SL peaks below a predefined array factor value; a second SL region between the second angle and a fourth angle including one or more second SL peaks below the predefined array factor value; a third SL region between the third angle and a fifth angle including one or more third SL peaks above the predefined array factor value; and a fourth SL region between the fourth angle and a sixth angle including one or more fourth SL peaks above the predefined array factor value.

### CROSS REFERENCE

This application claims the benefit of, and priority from, U.S. Provisional Patent Application No. 63/494,241 entitled “RADAR APPARATUS, SYSTEM, AND METHOD”, filed Apr. 5, 2023, and U.S. Provisional Patent Application No. 63/556,787 entitled “APPARATUS, SYSTEM, AND METHOD OF AN ANTENNA ARRAY”, filed Feb. 22, 2024, the entire disclosures of which are incorporated herein by reference.

### BACKGROUND

Various types of devices and systems, for example, wireless communication devices, may utilize an antenna array to communicate Radio Frequency (RF) signals.

For example, an antenna array (also referred to as an “array antenna”) may include a set of multiple antennas (antenna elements), which may be operated to transmit and/or receive RF signals.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10A is a schematic illustration of a uniform antenna array topology, FIG. 10B is a schematic illustration of a normalized antenna pattern of the uniform antenna array topology of FIG. 10A, FIG. 10C is a schematic illustration of a single element pattern of an antenna element of the uniform antenna array topology of FIG. 10A, and FIG. 10D is a schematic illustration of an array pattern response of the uniform antenna array topology of FIG. 10A, to demonstrate one or more technical aspects, which may be addressed in accordance with some demonstrative aspects.

FIG. 11A is a schematic illustration of a non-uniform antenna array topology, FIG. 11B is a schematic illustration of a normalized antenna pattern of the non-uniform antenna array topology of FIG. 11A, and FIG. 11C is a schematic illustration of an array pattern response of the non-uniform antenna array topology of FIG. 11A, to demonstrate one or more technical aspects, which may be addressed in accordance with some demonstrative aspects.

FIG. 12 is a schematic block diagram illustration of an apparatus including an antenna array, in accordance with some demonstrative aspects.

FIG. 13A is a schematic illustration of an antenna array topology, FIG. 13B is a schematic illustration of an array factor of the antenna array topology of FIG. 13A, and FIG. 13C is a schematic illustration of an array pattern of the antenna array topology of FIG. 13A, in accordance with some demonstrative aspects.

FIG. 14 is a schematic illustration of a MIMO antenna array topology, in accordance with some demonstrative aspects.

FIG. 15 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHZ, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

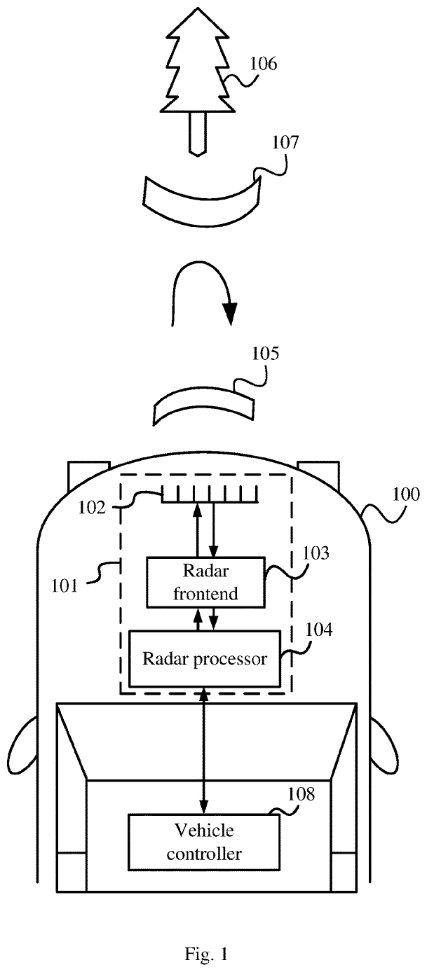

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below. In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and a one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

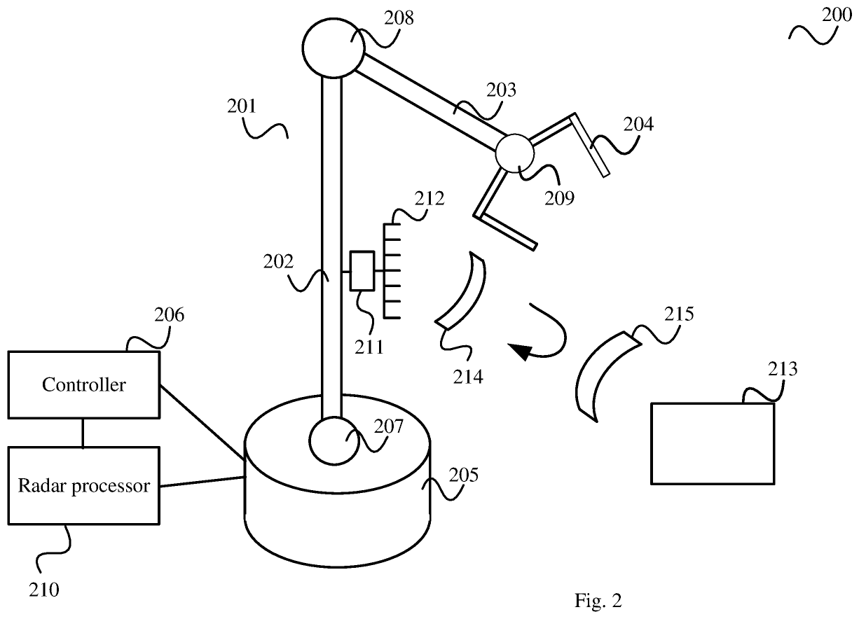

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e. actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

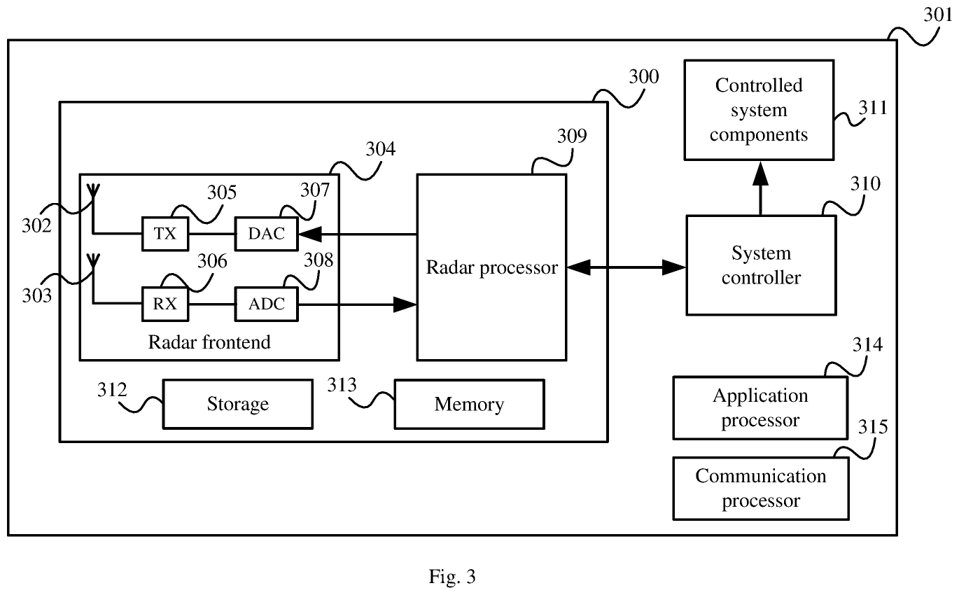

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 an/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, the radar information from radar processor 309 may be processed, e.g., by system controller 310 and/or any other element of system 301, for example, in combination with information from one or more other of information sources, for example, LiDAR information from a LiDAR processor, vision information from a vision-based processor, or the like.

In some demonstrative aspects, an environmental model of an environment of system 301 may be determined, e.g., by system controller 310 and/or any other element of system 301, for example, based on the radar information from radar processor 309, and/or the information from one or more other of information sources.

In some demonstrative aspects, a driving policy system, e.g., which may be implemented by system controller 310 and/or any other element of system 301, may process the environmental model, for example, to decide on one or more actions, which may be taken.

In some demonstrative aspects, system controller 310 may be configured to control one or more controlled system components 311 of the system 301, e.g. a motor, a brake, steering, and the like, e.g. by one or more corresponding actuators, for example, based on the one or more action decisions.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a Continuous Wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated continuous wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

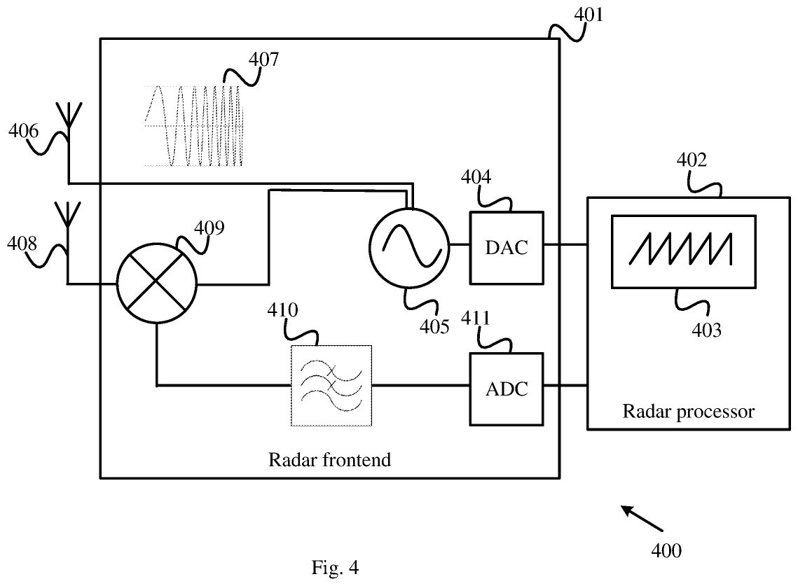

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, a radar device may be configured to utilize radio transmit signals having a form of chirps, e.g., chirps 407, for example, according to a chirp modulation, e.g., as described below.

In other aspects, the radar device may be configured to utilize radio transmit signals configured according to a Phase Modulation (PM), a digital modulation, an OFDM modulation, and/or any other suitable type of modulation.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

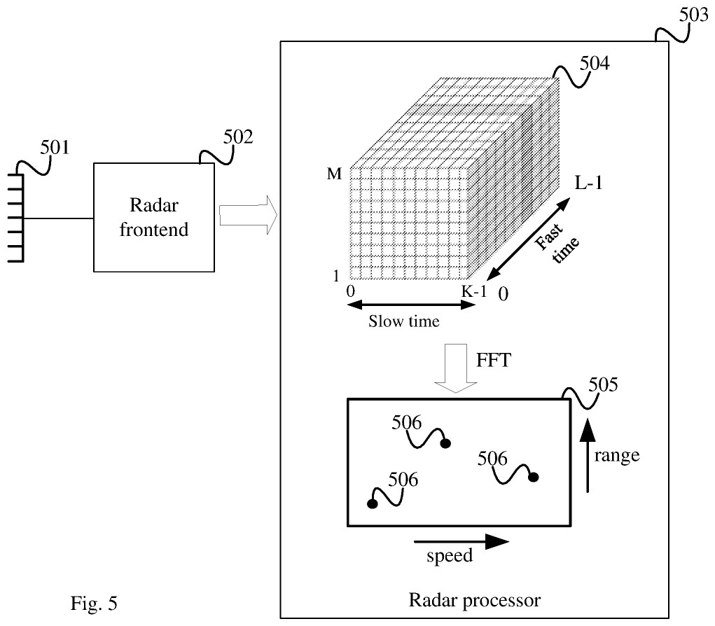

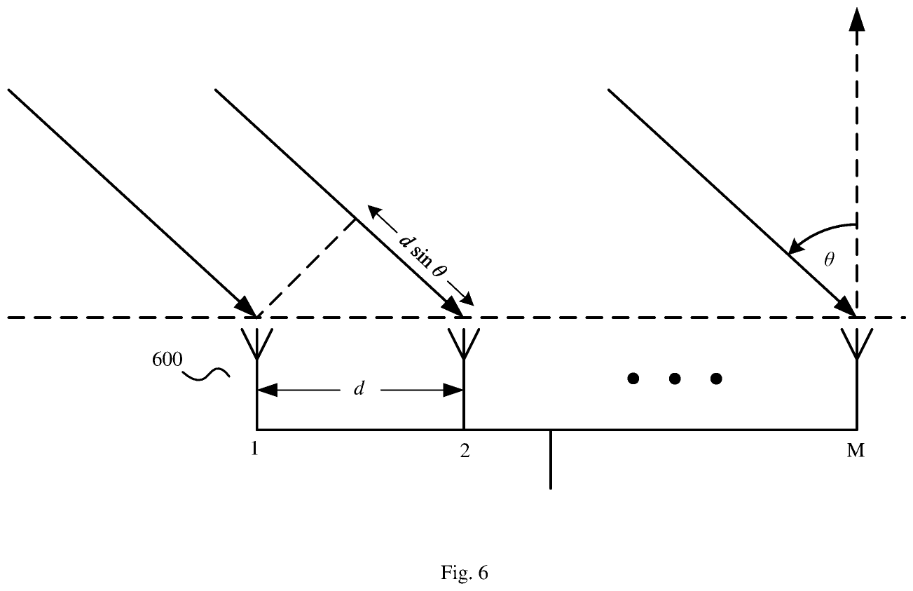

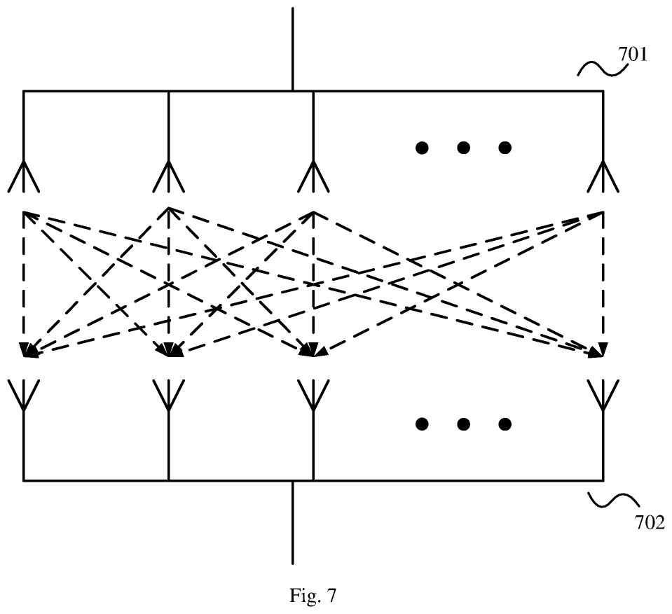

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time” direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time” direction of the data cube 504.

In some demonstrative aspects, processor 504 may be configured to determine the range values, Doppler values, and/or Angle of Arrival (AoA) values, e.g., Azimuth values and/or Elevation values, for example, based on FFT techniques, e.g., as described below.

In other aspects, processor 504 may be configured to determine the range values, Doppler values, and/or Angle of Arrival (AoA) values, e.g., Azimuth values and/or Elevation values, for example, based on Super-Resolution (SR) techniques, and/or any other suitable processing technique.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array. In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$Δφ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

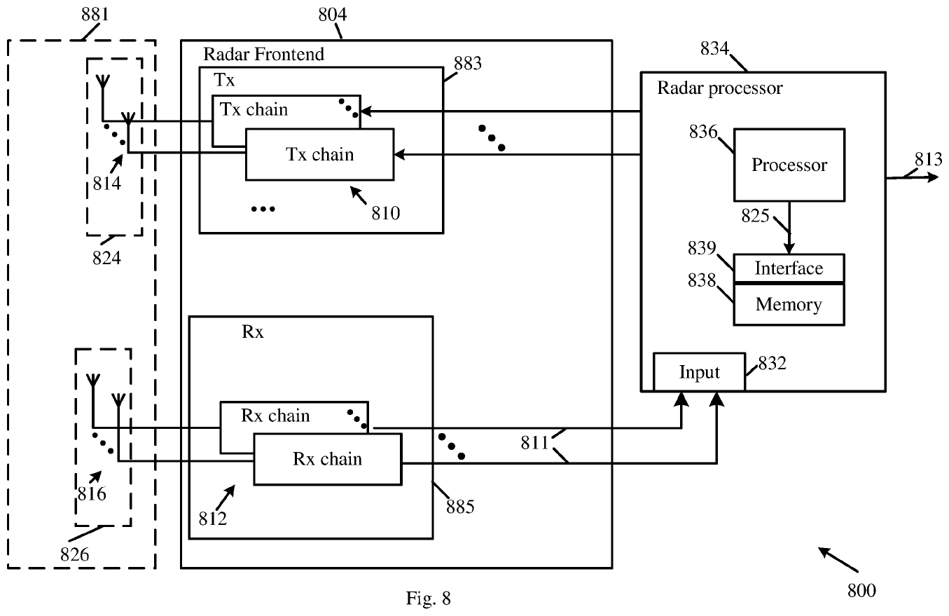

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design. In other aspects, any other form, shape and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, input 832 may include any suitable input interface, input unit, input module, input component, input circuitry, memory interface, memory access unit, memory reader, digital memory unit, bus interface, processor interface, or the like, which may be capable of receiving the radar input data from a memory, a processor, and/or any other suitable component to provide the radar input data.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm and/or procedure may be utilized to generate the range information and/or Doppler information.

In some demonstrative aspects, memory 838 may be configured to store AoA information, which may be generated by processor 836, for example, based on the radar Rx data, the range information and/or Doppler information. In one example, the AoA information may be determined based on an AoA estimation algorithm. Any other additional or alternative operation, algorithm and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth and/or Elevation.

In some demonstrative aspects, the radar information 813 may include additional information, which may be, for example, based on the raw point cloud estimations, and/or may be related to the raw point cloud estimations.

In some demonstrative aspects, the radar information 813 may include metadata information corresponding to the raw point cloud estimations.

In some demonstrative aspects, the radar information 813 may include, for example, information relating to a reliability level of the raw point cloud estimations, information relating to one or more parameters, conditions and/or criteria implemented in determining the raw point cloud estimations, and/or any other suitable additional or alternative information.

For example, the radar information 813 may include Log Likelihood Ratio (LLR) information corresponding to the raw point cloud estimations, Radar Cross Section (RCS) estimation information, SNR estimation information, and/or any other suitable additional or alternative information.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like. In one example, the PC2 information may be based on one or more temporal filtering techniques, which may be applied to the PC1 information, for example, for temporal filtering of multiple frames and/or multiple PC1 instances.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

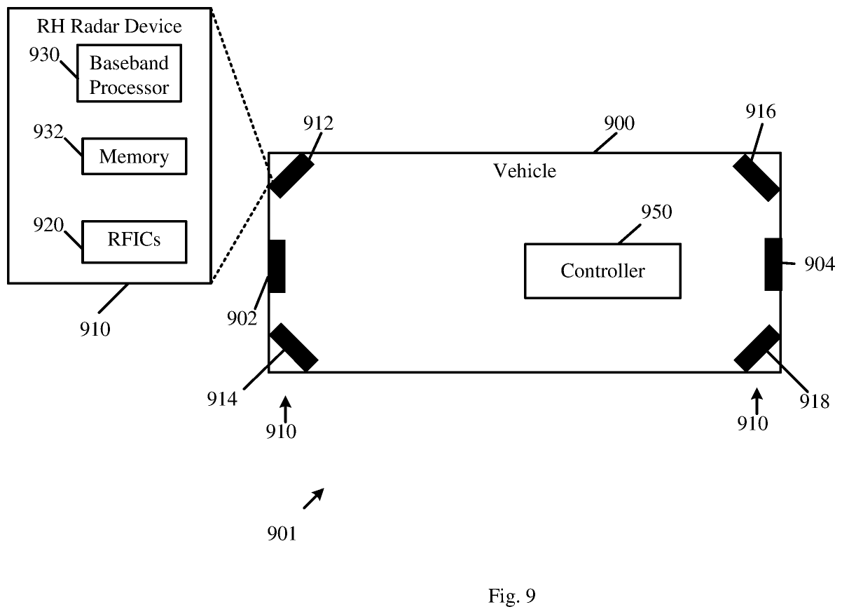

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, a radar device, e.g., as described above with reference to FIGS. 1-9, may be configured to implement one or more operations and/or functionalities of a hybrid uniform-sparse antenna array, e.g., as described below.

In some demonstrative aspects, a radar device, e.g., as described above with reference to FIGS. 1-9, may be configured to implement one or more operations and/or functionalities of a hybrid uniform-sparse antenna array with masked side lobe level, e.g., as described below.

For example, the hybrid uniform-sparse antenna array may combine attributes of uniform antenna arrays and attributes of non-uniform antenna arrays, e.g., as described below.

For example, uniform antenna arrays may provide a technical solution to support an ability to reach excellent Side Lobe Levels (SLL). However, uniform antenna arrays may suffer from poor resolution, for example, due to a small element spacing required for Grating Lobe (GL) suppression, e.g., as described below.

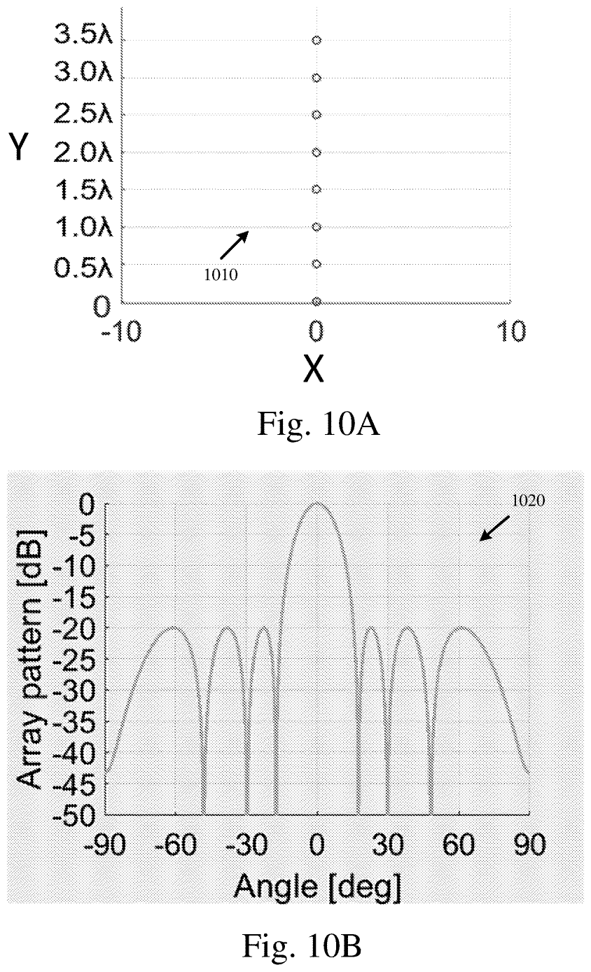

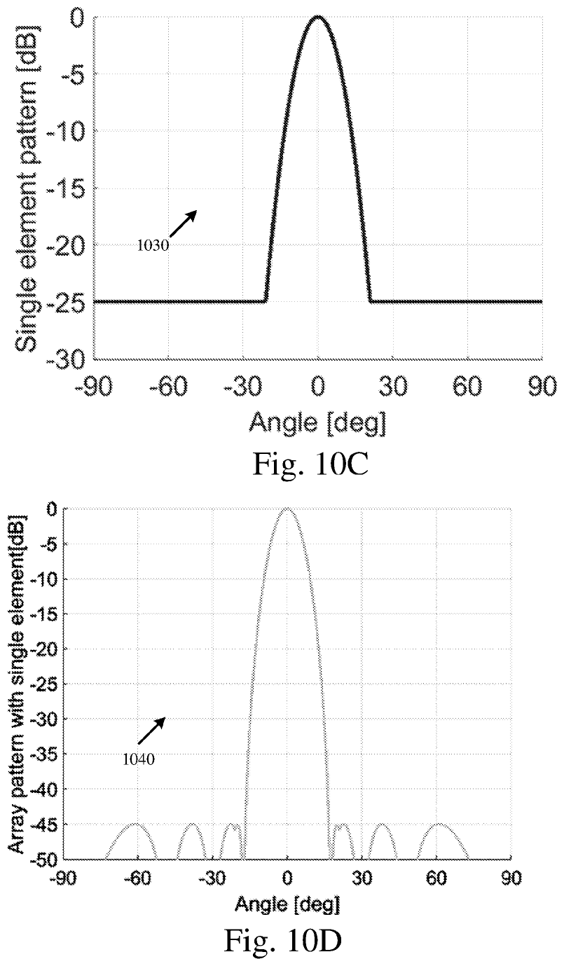

Reference is made to FIG. 10A, which schematically illustrates a uniform antenna array topology 1010, to FIG. 10B, which schematically illustrates a normalized antenna pattern 1020 of the uniform antenna array topology 1010, to FIG. 10C, which schematically illustrates a single element pattern 1030 of an antenna element of the uniform antenna array topology 1010, and to FIG. 10D, which schematically illustrates an array pattern response 1040 of the uniform antenna array topology 1010, to demonstrate one or more technical aspects, which may be addressed in accordance with some demonstrative aspects.

For example, as shown in FIG. 10A, uniform antenna array topology 1010 may include an 8-element uniform antenna array topology, for example, including eight antenna elements.

For example, the normalized antenna pattern 1020 (also referred to as an “array factor” or an “antenna factor”) may be determined, for example, without taking into account a contribution of a single element pattern, e.g., single element pattern 1030, of the uniform antenna array topology 1010.

For example, array pattern response 1040 of the uniform antenna array topology 1010 may represent a complete and accurate array pattern response, for example, after taking into account a single element rejection corresponding to the uniform antenna array topology 1010.

For example, uniform antenna array topology 1010 may correspond to a uniform half-wavelength spaced array, e.g., with 1.9 millimeter (mm) spacing, or any other suitable spacing, between antenna elements of uniform antenna array 1010, for example, at a frequency of 78.5 GHZ, or any other suitable frequency.

For example, the normalized antenna pattern 1020 may be determined based on the uniform antenna array topology 1010, for example, after applying a Chebyshev window, e.g., a conventional 20 decibel (dB) Chebyshev window, for example, without taking into account the contribution of the single element pattern 1030.

For example, as shown in FIG. 10C, the single element pattern 1030 may be very weak, for example, outside a Field of View (FOV), e.g., beyond 20 degrees (°).

For example, this behavior of the single element pattern 1030 may be common along an elevation dimension, for example, in an automotive radar implementation and/or any other implementation, for example, where a relatively narrow beam may be recommended, for example, in order to reduce reflections, e.g., from a road.

For example, as shown in FIG. 10D, an SLL of array pattern response 1040 may have an excellent value of 45 dB.

For example, as shown in FIG. 10D, array pattern response 1040 may not include any GL, for example, as the GL may not appear, e.g., due to the small element spacing.

For example, as shown in FIG. 10D, array pattern response 1040 may have a relatively poor 3 dB beamwidth, e.g., of about 10°, which is a relatively poor value. For example, a size of the 3 dB beamwidth may be used as an indication for a resolution and/or separation capability supported by uniform antenna array topology 1010.

In some demonstrative aspects, for example, in some use cases and/or scenarios, it may be disadvantageous to implement a uniform antenna array including a large number of array elements, for example, in order to reach an improved resolution and/or an improved SLL.

In one example, the large number of array elements may increase cost, size, and complexity. For example, it may be required to reduce the number of array elements in order to reduce the size and/or cost of such uniform antenna array. Accordingly, the uniform array may provide a poor resolution, and, therefore may be less recommended.

For example, non-uniform arrays may be utilized, e.g., instead of uniform arrays, for example, in order to reduce a number of array elements to achieve an improved resolution.

For example, non-uniform arrays may have higher resolution, e.g., compared to uniform arrays, and may avoid GL. However, the non-uniform arrays may have worse SLL, e.g., compared to the uniform arrays.

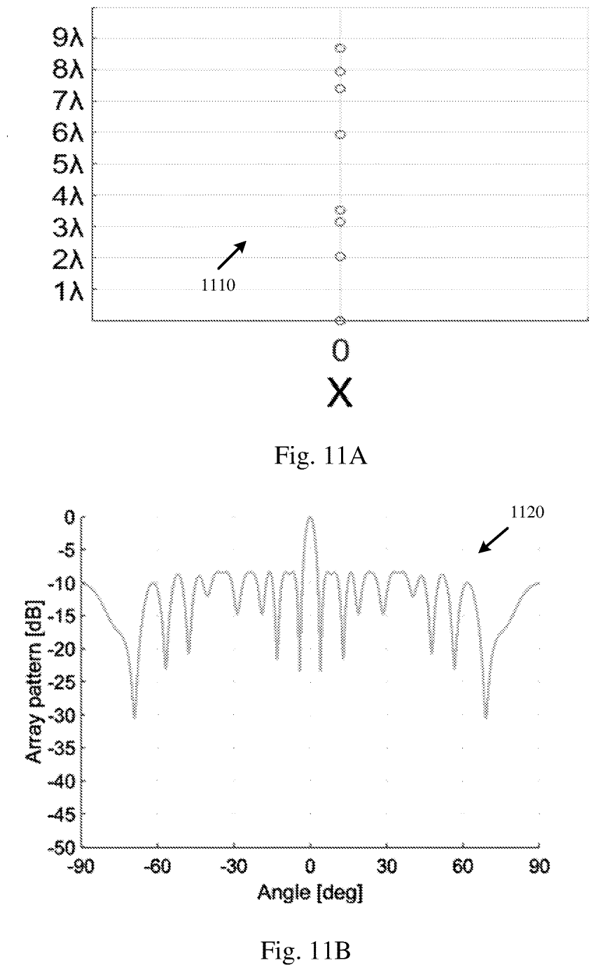

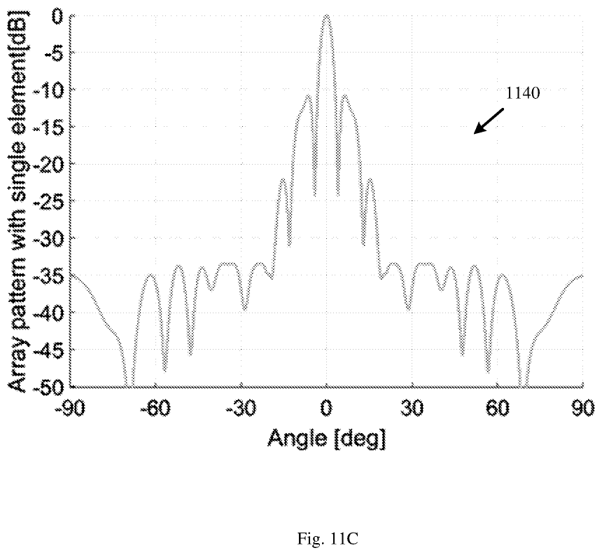

Reference is made to FIG. 11A, which schematically illustrates a non-uniform antenna array topology 1110, to FIG. 11B, which schematically illustrates a normalized antenna pattern 1120 of the non-uniform antenna array topology 1110, and to FIG. 11C, which schematically illustrates an array pattern response 1140 of the non-uniform antenna array topology 1110, to demonstrate one or more technical aspects, which may be addressed in accordance with some demonstrative aspects.

For example, as shown in FIG. 11A, non-uniform antenna array topology 1110 may include an 8-element non-uniform antenna array topology, for example, including eight antenna elements.

For example, the normalized antenna pattern 1120 may be determined, for example, without taking into account a contribution of a single element pattern of the non-uniform antenna array topology 1110.

For example, array pattern response 1140 of the non-uniform antenna array topology 1110 may represent a complete and accurate array pattern response, for example, after taking into account a single element rejection corresponding to the uniform antenna array topology 1110.

For example, the non-uniform antenna array topology 1110 may be optimized, for example, for a best SLL over an entire space, e.g., with angles up to angles of ±90°.

For example, element locations of the eight antenna elements of the non-uniform antenna array topology 1110, and/or a window, e.g., a unique window, may be determined, for example, based on a combined convex and non-convex optimization procedure.

For example, non-uniform antenna array topology 1110 may be configured with eight antenna elements, for example, to support a valid comparison between non-uniform antenna array topology 1110 and uniform antenna array topology 1010 (FIG. 10A).

For example, as shown in FIG. 11C array pattern response 1140 of non-uniform antenna array topology 1110 may not include any GL, similar to uniform antenna array topology 1010 (FIG. 10A), for example, although an average spacing between the eight antenna elements of non-uniform antenna array topology 1110 may be larger than a wavelength of signals to be communicated via the antenna array.

For example, as shown in FIG. 11C, array pattern response 1140 of non-uniform antenna array topology 1110 may have a 3 dB beamwidth of about 4°, which may be a relatively good value. The improved 3 dB beamwidth may be achieved, for example, as a result of an array size of non-uniform antenna array topology 1110, which may be much larger than an array size of uniform antenna array topology 1010 (FIG. 10A).

For example, as shown in FIG. 11C, array pattern response 1140 of non-uniform antenna array topology 1110 may have an SLL of about 11 dB, for example, even after applying an optimal window. This SLL of array pattern response 1140 may be much worse than the SLL value of array pattern response 1040 (FIG. 10D) corresponding to the uniform antenna array 1010 (FIG. 10A).

In some demonstrative aspects, a radar device, e.g., as described above with reference to FIGS. 1-9, may be configured to implement one or more operations and/or functionalities of a novel hybrid uniform-sparse antenna array topology, which may be configured to provide a technical solution to support a high resolution and/or a good SLL, for example, by employing a unique maximum likelihood (ML) processing, e.g., as described below.

In some demonstrative aspects, a single element rejection mask may be leveraged, for example, during an optimization process that searches for best array element locations for the hybrid uniform-sparse array topology, for example, such that further improvement in the SLL may be achieved, e.g., as described below.

In some demonstrative aspects, a radar device, e.g., as described above with reference to FIGS. 1-9, may be configured to implement one or more operations and/or functionalities of a hybrid uniform-sparse array topology, which may be configured to locate a first part of the array elements on a uniform grid, and a second part of the array elements on a non-uniform grid, e.g., as described below.

In some demonstrative aspects, the hybrid uniform-sparse array topology may be configured to provide a technical solution to support improved resolution and/or SLL, for example, by wisely processing and/or merging information from the uniform grid and the non-uniform grid, e.g., as described below.

In some demonstrative aspects, the hybrid uniform-sparse array topology may be configured to provide a technical solution to improve the SLL, for example, inside the FoV, e.g., only in the FoV, rather than trying to reduce the SLL at the entire space, e.g., including angles outside of the FoV. For example, the SLL may be improved, for example, by optimizing SLL values within the FoV, for example, while outside the FoV area a single element mask may attenuate the signal.

In some demonstrative aspects, the hybrid uniform-sparse array topology may be implemented to provide a technical solution to make use of the principals of a hybrid uniform-sparse array and SLL masking, for example, such that an overall high resolution and/or a very good SLL may be attained, e.g., compared to other solutions.

In some demonstrative aspects, the hybrid uniform-sparse array topology may be implemented to provide a technical solution to support high resolution and good SLL, for example, even with a relatively small number of elements, e.g., as described below.

In some demonstrative aspects, the hybrid uniform-sparse array topology may be implemented to provide a technical solution to reduce radar power consumption, cost, and/or compute power, e.g., by utilizing a reduced number of antenna elements.

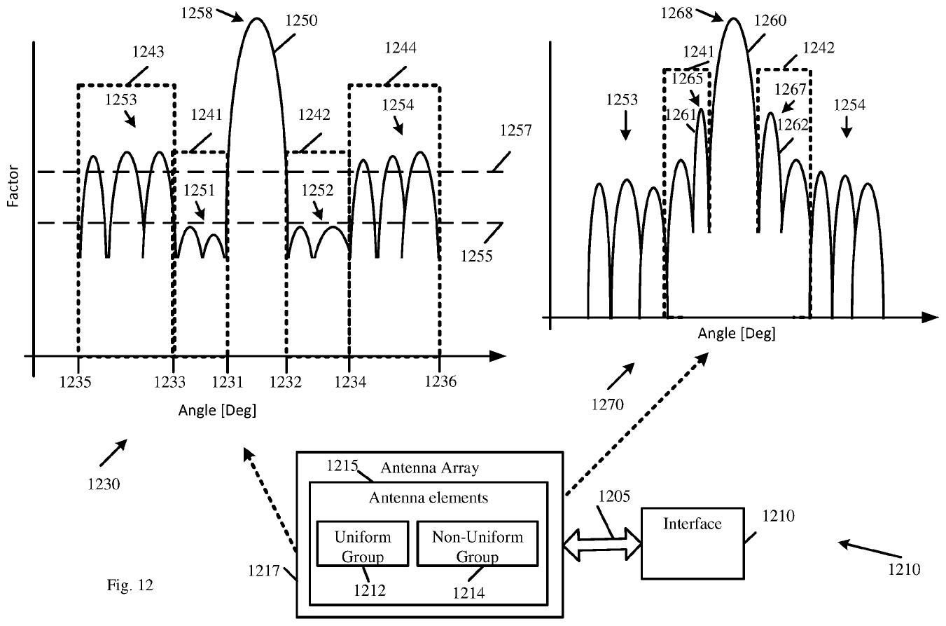

Reference is made to FIG. 12, which schematically illustrates an apparatus 1200 including an antenna array 1217, in accordance with some demonstrative aspects.

In some demonstrative aspects, antenna array 1217 may include a Tx antenna array, which may be configured to transmit RF Tx signals, e.g., as described below.

In one example, the one or more Tx arrays 824 (FIG. 8) may include one or more elements of antenna array 1217, and/or may perform one or more operations and/or functionalities of antenna array 1217.

In some demonstrative aspects, antenna array 1217 may include an Rx antenna array, which may be configured to receive RF Rx signals, e.g., as described below.

In one example, the one or more Rx arrays 826 (FIG. 8) may include one or more elements of antenna array 1217, and/or may perform one or more operations and/or functionalities of antenna array 1217.

In some demonstrative aspects, antenna array 1217 may include a plurality of antenna elements 1215, which may be arranged according to an array arrangement, e.g., as described below.

In some demonstrative aspects, the array arrangement may be configured to provide a predefined array factor 1230, e.g., as described below.

In some demonstrative aspects, the predefined array factor 1230 may include a main beam 1250, which may be between a first angle 1231 and a second angle 1232, e.g., as described below.

In some demonstrative aspects, the predefined array factor 1230 may include a first Side-Lobe (SL) region 1241, which may be between the first angle 1231 and a third angle 1233, which may be less than the first angle 1231, e.g., as described below.

In some demonstrative aspects, the first SL region 1241 may include one or more first SL peaks 1251, which may be below a predefined array factor value 1255, e.g., as described below.

In some demonstrative aspects, the predefined array factor 1230 may include a second SL region 1242, which may be between the second angle 1232 and a fourth angle 1234, which may be larger than the second angle 1232, e.g., as described below.

In some demonstrative aspects, the second SL region 1242 may include one or more second SL peaks 1252, which may be below the predefined array factor value 1255, e.g., as described below.

In some demonstrative aspects, the predefined array factor 1230 may include a third SL region 1243, which may be between the third angle 1233 and a fifth angle 1235, which may be less than the third angle 1233, e.g., as described below.

In some demonstrative aspects, the third SL region 1243 may include one or more third SL peaks 1253, which may be above the predefined array factor value 1255, e.g., as described below.

In some demonstrative aspects, the predefined array factor 1230 may include a fourth SL region 1244, which may be between the fourth angle 1234 and a sixth angle 1236, which may be larger than the fourth angle 1234, e.g., as described below.

In some demonstrative aspects, the fourth SL region 1244 may include one or more fourth SL peaks 1254, which may be above the predefined array factor value 1255, e.g., as described below.

In some demonstrative aspects, system 1200 may include an interface 1210, which may be configured to communicate RF signals 1205 via the antenna array 1217, e.g., as described below.

In some demonstrative aspects, interface 1210 may include one or more elements of, and/or may be configured to perform one or more functionalities of, RF frontend 804 (FIG. 8).

For example, interface 1210 may include one or more elements of, and/or may be configured to perform one or more functionalities of, transmitter 883 (FIG. 8) and/or Tx chains 810 (FIG. 8), for example, in case antenna array 1217 includes a Tx antenna array.

For example, interface 1210 may include one or more elements of, and/or may be configured to perform one or more functionalities of, receiver 885 (FIG. 8) and/or Rx chains 812 (FIG. 8), for example, in case antenna array 1217 includes an Rx antenna array.

In some demonstrative aspects, the RF signals 1205 may include signals at a frequency above 70 GHz, e.g., as described below.

In other aspects, the RF signals 1205 may include signals at any other frequency.

In some demonstrative aspects, the RF signals 1205 may include signals in a frequency bandwidth of 76-81 GHz, e.g., as described below.

In other aspects, the RF signals 1205 may include signals in any other suitable frequency bandwidth.

In some demonstrative aspects, apparatus 1200 may be implemented as part of a radar device or system, for example, as part of radar device 800 (FIG. 8), e.g., as described above.

In some demonstrative aspects, apparatus 1200 may be implemented as part of any other suitable device and/or system.

For example, in some demonstrative aspects, apparatus 1200 may be implemented as part of a device, for example, a mobile device, a computing device, and/or a wireless communication device, for example, to communicate RF wireless communication signals.

For example, in some demonstrative aspects, apparatus 1200 may be implemented to communicate the RF wireless communication signals over mmWave frequencies and/or any other suitable frequencies.

In some demonstrative aspects, all SLs within the first SL region 1241 may be below the predefined array factor value 1255, e.g., as described below.

In some demonstrative aspects, all SLs within the second SL region 1242 may be below the predefined array factor value 1255, e.g., as described below.

In some demonstrative aspects, all SLs within the first SL region 1241, and all SLs within the second SL region 1242 may be below the predefined array factor value 1255, e.g., as described below.

In other aspects, first SL region 1241 and/or second SL region 1242 may include a SL peak equal to or above the predefined array factor value 1255.

In some demonstrative aspects, the main beam 1250 may have a 3 dB beamwidth of less than 10 degrees, e.g., as described below.

In some demonstrative aspects, the main beam 1250 may have a 3 dB beamwidth of less than 8 degrees, e.g., as described below.

In some demonstrative aspects, the main beam 1250 may have a 3 dB beamwidth of less than 7 degrees, e.g., as described below.

In some demonstrative aspects, the main beam 1250 may have a 3 dB beamwidth of less than 5 degrees, e.g., as described below.

In some demonstrative aspects, the main beam 1250 may have a 3 dB beamwidth of 4 degrees or less, e.g., as described below.

In other aspects, the main beam 1250 may have any other 3 dB beamwidth.

In some demonstrative aspects, a difference between the fourth angle 1234 and the third angle 1233 may be based, for example, on a beamwidth of a single-element beam of an antenna element of the plurality of antenna elements 1215, e.g., as described below.

In some demonstrative aspects, the difference between the fourth angle 1234 and the third angle 1233 may be, for example, substantially equal to or greater than the beamwidth of the single-element beam of the antenna element of the plurality of antenna elements 1215, e.g., as described below.

In some demonstrative aspects, the difference between the fourth angle 1234 and the third angle 1233 may be at least 50 degrees, e.g., as described below.

In some demonstrative aspects, the difference between the fourth angle 1234 and the third angle 1233 may be at least 60 degrees, e.g., as described below.

In some demonstrative aspects, the difference between the fourth angle 1234 and the third angle 1233 may be at least 70 degrees, e.g., as described below.

In other aspects, there may be any other suitable difference between the fourth angle 1234 and the third angle 1233.

In some demonstrative aspects, there may be a difference of at least 160 degrees between the sixth angle 1236 and the fifth angle 1235, e.g., as described below.

In some demonstrative aspects, there may be a difference of at least 170 degrees between the sixth angle 1236 and the fifth angle 1235, e.g., as described below.

In other aspects, there may be any other suitable difference between the sixth angle 1236 and the fifth angle 1235.

In some demonstrative aspects, the predefined array factor value 1255 may be, for example, at least 8 dB below a peak 1258 of the main beam 1250, e.g., as described below.

In some demonstrative aspects, the predefined array factor value 1255 may be, for example, at least 10 dB below the peak 1258 of the main beam 1250, e.g., as described below.

In other aspects, the array factor value 1255 may be configured to be at any other suitable distance from the peak 1258 of the main beam 1250.

In some demonstrative aspects, the predefined array factor value 1255 may be implemented as a first array factor value 1255, e.g., as described below.

In some demonstrative aspects, the third SL peaks 1253 and the fourth SL peaks may be above a second array factor value 1257, which may be greater than the first array factor value 1255, e.g., as described below.

In some demonstrative aspects, there may be a difference, for example, of at least 3 dB, between the second array factor value 1257 and the first array factor value 1255, e.g., as described below.

In some demonstrative aspects, there may be a difference, for example, of at least 4 dB, between the second array factor value 1257 and the first array factor value 1255, e.g., as described below.

In other aspects, there may be any other suitable difference between the second array factor value 1257 and the first array factor value 1255.

In some demonstrative aspects, the plurality of antenna elements 1215 may include a first group of antenna elements 1212, and a second group of antenna elements 1214, e.g., as described below.

In some demonstrative aspects, the first group of antenna elements 1212 may be arranged according to a uniform arrangement, for example, including a uniform spacing between antenna elements of the first group of antenna elements 1212, e.g., as described below.

In some demonstrative aspects, the second group of antenna elements 1214 may be arranged according to a non-uniform arrangement including a non-uniform spacing between antenna elements of the second group of antenna elements 1214, e.g., as described below.

In some demonstrative aspects, the second group of antenna elements 1214 may include, for example, at least 35 percent of the plurality of antenna elements 1215, e.g., as described below.

In some demonstrative aspects, the second group of antenna elements 1214 may include, for example, at least 40 percent of the plurality of antenna elements 1215, e.g., as described below.

In some demonstrative aspects, the second group of antenna elements 1214 may include, for example, at least 50 percent of the plurality of antenna elements 1215, e.g., as described below.

In some demonstrative aspects, the second group of antenna elements 1214 may include, for example, at least 60 percent of the plurality of antenna elements 1215, e.g., as described below.

In other aspects, the second group of antenna elements 1214 may include any other percentage of the plurality of antenna elements 1215.

In other aspects, the plurality of antenna elements 1215 may be arranged according to any other arrangement, including any other suitable groups of antenna elements, e.g., uniformly-spaced antenna elements and/or nonuniformly-spaced antenna elements.

In some demonstrative aspects, antenna array 1217 may be configured to have an array pattern 1270, e.g., as described below.

In some demonstrative aspects, the array pattern 1270 of the antenna array 1217 may include an antenna-pattern main beam 1260, e.g., as described below.

In some demonstrative aspects, the array pattern 1270 of the antenna array 1217 may include a first antenna-pattern SL 1261, which may be adjacent to a first side of the antenna-pattern main beam 1260, e.g., as described below.

In some demonstrative aspects, the first antenna-pattern SL 1261 may be in the first SL region 1241, e.g., as described below.

In some demonstrative aspects, the array pattern 1270 of the antenna array 1217 may include a second antenna-pattern SL 1262, which may be adjacent to a second side of the antenna-pattern main beam 1260, e.g., as described below.

In some demonstrative aspects, the second antenna-pattern SL 1262 may be in the second SL region 1242, e.g., as described below.

In some demonstrative aspects, a peak 1265 of the first antenna-pattern SL 1261 and a peak 1267 of the second antenna-pattern SL 1262 may be higher than any other SLs in the antenna pattern 1270, e.g., as described below.

In some demonstrative aspects, the peak 1265 of the first antenna-pattern SL 1261 and the peak 1267 of the second antenna-pattern SL 1262 may be, for example, at least 10 dB below a peak 1268 of the antenna-pattern main beam 1260, e.g., as described below.

In some demonstrative aspects, the peak 1265 of the first antenna-pattern SL 1261 and the peak 1267 of the second antenna-pattern SL 1262 may be, for example, at least 12 dB below the peak 1268 of the antenna-pattern main beam 1260, e.g., as described below.

In some demonstrative aspects, the peak 1265 of the first antenna-pattern SL 1261 and the peak 1267 of the second antenna-pattern SL 1262 may be, for example, at least 15 dB below the peak 1268 of the antenna-pattern main beam 1260, e.g., as described below.

In other aspects, the array pattern 1270 may be configured with any other difference between the peak 1268 and the peaks 1265 and 1267.

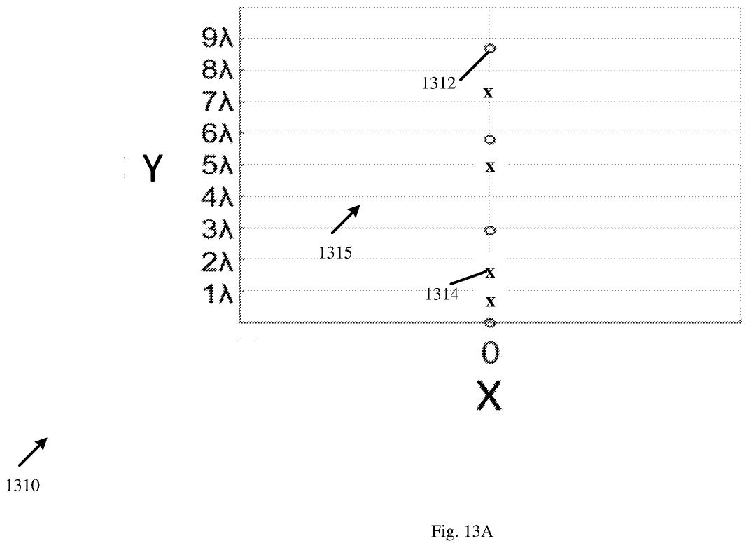

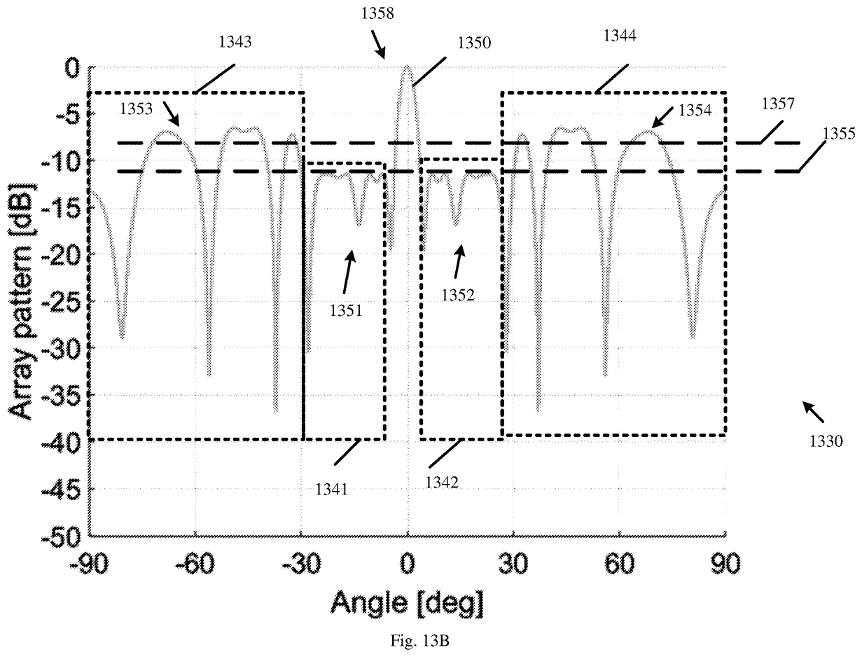

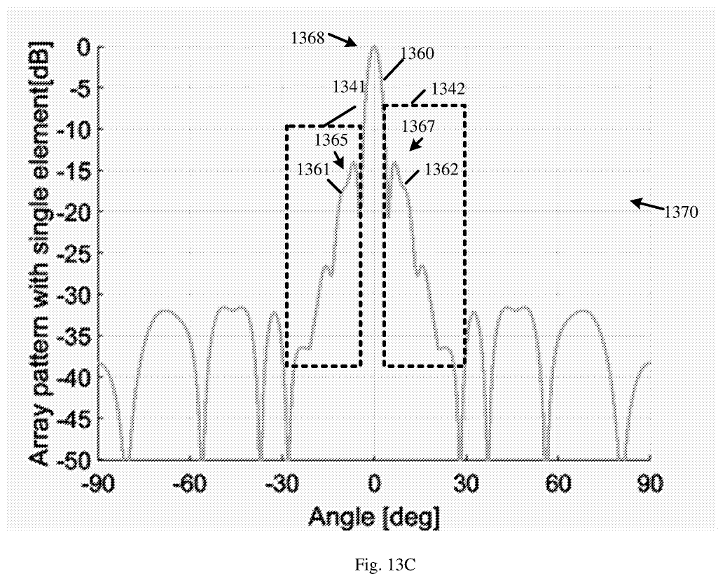

Reference is made to FIG. 13A, which schematically illustrates an antenna array topology 1310, to FIG. 13B, which schematically illustrates an array factor 1330 of the antenna array topology 1310, and to FIG. 13C, which schematically illustrates an array pattern 1370 of the antenna array topology 1310, in accordance with some demonstrative aspects.

In some demonstrative aspects, as shown in FIG. 13A, antenna array topology 1310 may be configured according to an antenna array topology with hybrid uniform-sparse elements.

In some demonstrative aspects, as shown in FIG. 13A, antenna array topology 1310 may include a plurality of antenna elements 1315.

In some demonstrative aspects, as shown in FIG. 13A, the plurality of antenna elements 1315 may include a first group of antenna elements 1312, denoted by circles (∘), and a second group of antenna elements 1314, denoted “x”.

In some demonstrative aspects, as shown in FIG. 13A, the first group of antenna elements 1312 may be arranged according to a uniform arrangement, for example, including a uniform spacing between antenna elements 1312 of the first group of antenna elements 1312.

In some demonstrative aspects, as shown in FIG. 13A, the second group of antenna elements 1314 may be arranged according to a non-uniform arrangement including a non-uniform spacing between antenna elements 1314 of the second group of antenna elements 1314.

In some demonstrative aspects, as shown in FIG. 13A, the second group of antenna elements 1314 may include 50 percent of the plurality of antenna elements 1315, e.g., four antenna elements 1314 out of a total of eight antenna elements 1315.

For example, as shown in FIG. 13A, the hybrid uniform-sparse array may be configured to include a plurality of uniformly spaced elements, e.g., the first group of antenna elements 1312.

For example, as shown in FIG. 13A, the hybrid uniform-sparse array may include four uniformly spaced elements 1312, e.g., four antenna elements 1312 out of the total of eight antenna elements 1315.

For example, as shown in FIG. 13A, the hybrid uniform-sparse array may be configured to include a plurality of non-uniformly spaced elements, e.g., the second group of antenna elements 1314.

For example, as shown in FIG. 13A, the hybrid uniform-sparse array may include four non-uniformly spaced elements 1314, e.g., four antenna elements 1314 out of the total of eight antenna elements 1315, which may not be equally spaced.

In some demonstrative aspects, any other count of antenna elements 1315 and/or any other type of partitions between the non-uniformly spaced elements 1314 and the uniformly spaced elements 1312 may be possible as well.

In some demonstrative aspects, array factor 1330 may represent a normalized array pattern, e.g., without taking into account a contribution of a single element of the antenna array topology 1310.

In some demonstrative aspects, as shown in FIG. 13B, array factor 1330 may include a main beam 1350, which may be between an angle of about −5° and an angle of about 5°.

In some demonstrative aspects, as shown in FIG. 13B, array factor 1330 may include a first SL region 1341, which may be between the angle of about −5° and an angle of about −30°.

In some demonstrative aspects, as shown in FIG. 13B, the first SL region 1341 may include one or more first SL peaks 1351, which may be below a predefined array factor value 1355.

In some demonstrative aspects, array factor 1330 may include a second SL region 1342, which may be between the angle of about 5° and an angle of about 30°.

In some demonstrative aspects, as shown in FIG. 13B, the second SL region 1342 may include one or more second SL peaks 1352, which may be below the predefined array factor value 1355.

In some demonstrative aspects, as shown in FIG. 13B, array factor 1330 may include a third SL region 1343, which may be between the angle of about −30° and an angle of about −90°.

In some demonstrative aspects, as shown in FIG. 13B, the third SL region 1343 may include one or more third SL peaks 1353, which may be above the predefined array factor value 1355.

In some demonstrative aspects, as shown in FIG. 13B, the predefined array factor 1330 may include a fourth SL region 1344, which may be between the angle of about 30° and an angle of about 90°.

In some demonstrative aspects, as shown in FIG. 13B, the fourth SL region 1344 may include one or more fourth SL peaks 1354, which may be above the predefined array factor value 1355.

In some demonstrative aspects, as shown in FIG. 13B, all SLs within the first SL region 1341, and all SLs within the second SL region 1342 may be below the predefined array factor value 1355.

In some demonstrative aspects, as shown in FIG. 13B, the main beam 1350 may have a 3 dB beamwidth of about 4 degrees, which may be an excellent 3 dB beamwidth.

In some demonstrative aspects, as shown in FIG. 13B, the predefined array factor value 1355 may be, for example, at least 10 dB below a peak 1358 of the main beam 1350.

In some demonstrative aspects, as shown in FIG. 13B, the third SL peaks 1353 and the fourth SL peaks may be above an array factor value 1357, which may be greater than the array factor value 1355.

In some demonstrative aspects, as shown in FIG. 13B, there may be a difference, for example, of at least 3 dB, between the array factor value 1357 and the array factor value 1355.

In some demonstrative aspects, as shown in FIG. 13B, SLLs of array factor 1330 may be optimized, e.g., only inside a FoV in a range of angles between ±30°, and a masked SLL behavior, e.g., a step at the angles ±30°, may be created.

In some demonstrative aspects, array pattern 1370 may represent a normalized array pattern with a contribution of the single element of the antenna array topology 1310.

In some demonstrative aspects, array pattern 1370 may represent a complete and accurate array pattern response of the antenna array topology 1310, for example, while taking into account a single element rejection.

In some demonstrative aspects, as shown in FIG. 13C, the array pattern 1370 of the antenna array topology 1310 may include an antenna-pattern main beam 1360.

In some demonstrative aspects, as shown in FIG. 13C, the array pattern 1370 of the antenna array topology 1310 may include a first antenna-pattern SL 1361, which may be adjacent to a first side of the antenna-pattern main beam 1360.

In some demonstrative aspects, as shown in FIG. 13C, the first antenna-pattern SL 1361 may be in the first SL region 1341.

In some demonstrative aspects, as shown in FIG. 13C, the array pattern 1370 of the antenna array topology 1310 may include a second antenna-pattern SL 1362, which may be adjacent to a second side of the antenna-pattern main beam 1360.

In some demonstrative aspects, as shown in FIG. 13C, the second antenna-pattern SL 1362 may be in the second SL region 1342.

In some demonstrative aspects, as shown in FIG. 13C, a peak 1365 of the first antenna-pattern SL 1361 and a peak 1367 of the second antenna-pattern SL 1362 may be higher than any other SLs in the antenna pattern 1370.

In some demonstrative aspects, as shown in FIG. 13C, the peaks 1365 and 1367 may be, for example, at least 13 dB below a peak 1368 of the antenna-pattern main beam 1360.

In some demonstrative aspects, as shown in FIG. 13C, SLLs of array pattern 1370 beyond a FoV of ±30°, e.g., the true SLLs of array pattern 1370, may be below −30 dB. These relatively low SLL levels may be achieved, for example, despite the relatively poor SLLs of array factor 1330 (FIG. 13B) beyond the FoV of ±30°, which may be above −11 dB.

In some demonstrative aspects, as shown in FIG. 13C, SLLs of array pattern 1370 in the FoV of ±30° may reach 14 dB, which may be better than the SLLs in the FoV of ±30° of the array pattern 1140 (FIG. 11C) of non-uniform array topology 1110 (FIG. 11A).

In some demonstrative aspects, this improvement of the SLLs of array pattern 1370 in the FoV of ±30°, e.g., compared to the SLLs of array pattern 1140 (FIG. 11C) in the FoV of ±30°, may be achieved, for example, by inserting a masked SLL constraint to an optimization, for example, such that a best SLL value may be searched, e.g., only inside the relevant FoV, e.g., in the FoV of ±30°.

In some demonstrative aspects, this improved SLL in the FoV of ±30° may be achieved, for example, as less angles may be needed to be checked.

In some demonstrative aspects, for example, outside the FoV of ±30°, the single element may attenuate the signal and, therefore, a relatively good SLL may be guaranteed, for example, even if this area is not included in the optimization.

In some demonstrative aspects, an additional improvement of the SLL may be achieved, for example, by employing a unique ML processing, which may take advantage of the uniform part of the antenna array 1310.

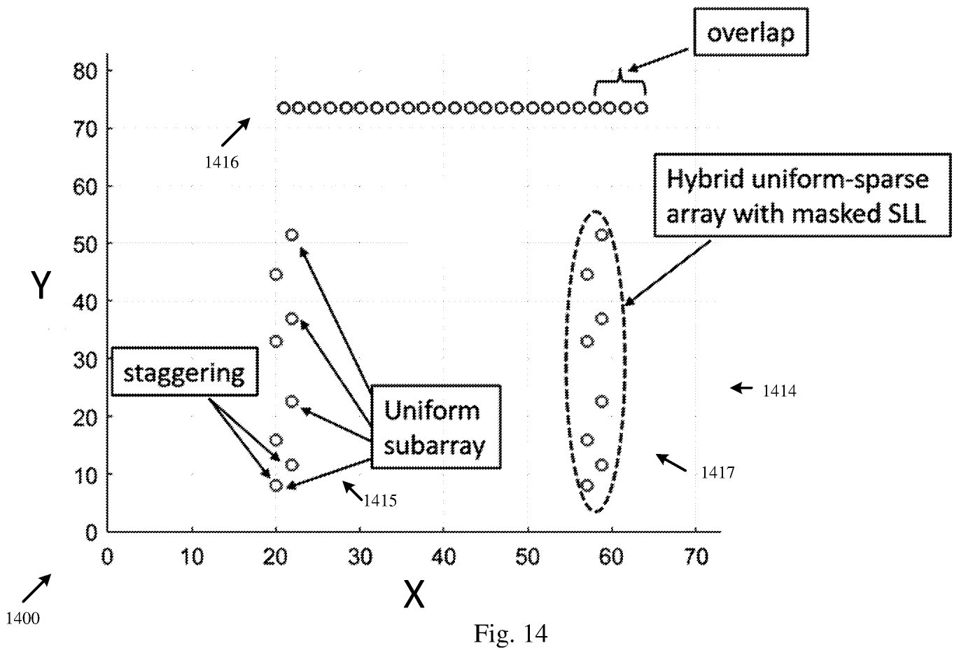

Reference is made to FIG. 14, which schematically illustrates a MIMO antenna array topology 1400, in accordance with some demonstrative aspects. For example, MIMO radar antenna 881 (FIG. 8) may include one or more elements of MIMO antenna array topology 1400.

In some demonstrative aspects, as shown in FIG. 14, MIMO antenna array topology 1400 may include an Rx array 1416 including a plurality of Rx antennas.

In some demonstrative aspects, as shown in FIG. 14, MIMO antenna array topology 1400 may include a plurality of Tx antennas 1414. For example, the plurality of antenna elements 1215 (FIG. 12) may include one or more elements of the plurality of Tx antennas 1414.

In some demonstrative aspects, as shown in FIG. 14, MIMO antenna array topology 1400 may include a first Tx sub-array 1415 including a plurality of first Tx antennas 1414.

In some demonstrative aspects, as shown in FIG. 14, MIMO antenna 1400 may include a second Tx sub-array 1417 including a plurality of second Tx antennas 1414.

In some demonstrative aspects, an array topology of the plurality of Tx antennas 1414 may serve as a Tx array and may be combined with a row Rx array, e.g., Rx array 1416, for example, such that a complete 2D radar array may be formed.

In some demonstrative aspects, as shown in FIG. 14, the Tx antennas 1414 of the first Tx sub-array 1415 and/or the second Tx sub-array 1417 may be arranged in a staggered manner, for example, such that more space may be allocated per Tx element 1414.

For example, the staggered arrangement of the Tx antennas 1414 of the first Tx sub-array 1415 and/or the second Tx sub-array 1417 may be configured to provide a technical solution to allocate more space to each Tx antenna element 1414, and hence an antenna gain of MIMO antenna array topology 1400 may be improved, for example, to improve a link budget.

In some demonstrative aspects, as shown in FIG. 14, a row-column structure of MIMO antenna array topology 1400 may include two Tx columns, e.g., the first Tx sub-array 1415 and the second Tx sub-array 1417, and a single Rx row, e.g., Rx array 1416, e.g., including a uniform array with a half-wavelength spacing.

In some demonstrative aspects, the row-column structure of MIMO antenna array topology 1400 may be configured to provide a technical solution to reduce False Alarms (FA), for example, even when operating in multipath environments.

In some demonstrative aspects, additional multipath advantages may be achieved, for example, by choosing a distance between the two Tx columns to be smaller than a length of the Rx row.

For example, in this way, virtual arrays formed by first Tx sub-array 1415 and the second Tx sub-array 1417 may be overlapped. For example, a first virtual array, which may be formed based on a combination of Tx antennas from the first Tx sub-array 1415 with Rx antennas of the Rx array 1416, may have an overlap with a second virtual array, which may be formed based on a combination of Tx antennas from the second Tx sub-array 1417 with Rx antennas of the Rx array 1416. Accordingly, phase averaging along overlapped sections of the virtual arrays may be performed, for example, to further reduce the FA, e.g., in a multipath environment.

In some demonstrative aspects, MIMO antenna array topology 1400 may be implemented to provide a technical solution to support an improved SLL along an azimuth dimension, for example, by implementing the Rx array 1416 as a uniformly-spaced array.

In some demonstrative aspects, MIMO antenna array topology 1400 may be implemented to provide a technical solution to support immunity to FA, e.g., in a multipath environment, for example, by implementing the RX array as a uniformly-spaced array to be ambiguity free, and by implementing the row-column structure of MIMO antenna array topology 1400, for example, along with overlap and phase averaging in the virtual array.

In some demonstrative aspects, MIMO antenna array topology 1400 may be implemented to provide a technical solution to support an improved link budget, for example, using the staggering in the Tx sub-arrays 1415 and 1417, which may support an increased element size, and hence increased gain.

In some demonstrative aspects, MIMO antenna array topology 1400 may be implemented to provide a technical solution to support achieving good resolution and/or SLL along an elevation dimension, for example, using a concept of a hybrid uniform-sparse Tx array with masked SLL, e.g., as described above.

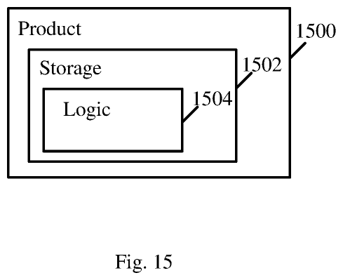

Reference is made to FIG. 15, which schematically illustrates a product of manufacture 1500, in accordance with some demonstrative aspects. Product 1500 may include one or more tangible computer-readable (“machine-readable”) non-transitory storage media 1502, which may include computer-executable instructions, e.g., implemented by logic 1504, operable to, when executed by at least one computer processor, enable the at least one computer processor to implement one or more operations and/or functionalities described with reference to any of the FIGS. 1-14 and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1500 and/or machine-readable storage media 1502 may include one or more types of computer-readable storage media capable of storing data, including volatile memory, non-volatile memory, removable or non-removable memory, erasable or non-erasable memory, writeable or re-writeable memory, and the like. For example, machine-readable storage media 1402 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising an antenna array comprising a plurality of antenna elements arranged according to an array arrangement configured to provide a predefined array factor comprising a main beam between a first angle and a second angle; a first Side-Lobe (SL) region between the first angle and a third angle less than the first angle, wherein the first SL region comprises one or more first SL peaks below a predefined array factor value; a second SL region between the second angle and a fourth angle larger than the second angle, wherein the second SL region comprises one or more second SL peaks below the predefined array factor value; a third SL region between the third angle and a fifth angle less than the third angle, wherein the third SL region comprises one or more third SL peaks above the predefined array factor value; and a fourth SL region between the fourth angle and a sixth angle larger than the fourth angle, wherein the fourth SL region comprises one or more fourth SL peaks above the predefined array factor value; and an interface to communicate Radio Frequency (RF) signals via the antenna array.

Example 2 includes the subject matter of Example 1, and optionally, wherein the plurality of antenna elements comprises a first group of antenna elements arranged according to a uniform arrangement comprising a uniform spacing between antenna elements of the first group of antenna elements; and a second group of antenna elements arranged according to a non-uniform arrangement comprising a non-uniform spacing between antenna elements of the second group of antenna elements.

Example 3 includes the subject matter of Example 2, and optionally, wherein the second group of antenna elements comprises at least 35 percent of the plurality of antenna elements.

Example 4 includes the subject matter of Example 2, and optionally, wherein the second group of antenna elements comprises at least 40 percent of the plurality of antenna elements.

Example 5 includes the subject matter of Example 2, and optionally, wherein the second group of antenna elements comprises at least 50 percent of the plurality of antenna elements.

Example 6 includes the subject matter of any one of Examples 1-5, and optionally, wherein an array pattern of the antenna array comprises an antenna-pattern main beam; a first antenna-pattern SL adjacent to a first side of the antenna-pattern main beam, the first antenna-pattern SL in the first SL region; and a second antenna-pattern SL adjacent to a second side of the antenna-pattern main beam, the second antenna-pattern SL in the second SL region, wherein peaks of the first antenna-pattern SL and the second antenna-pattern SL are higher than any other SLs in the antenna pattern.

Example 7 includes the subject matter of Example 6, and optionally, wherein the peaks of the first antenna-pattern SL and the second antenna-pattern SL are at least 10 decibel (dB) below a peak of the antenna-pattern main beam.

Example 8 includes the subject matter of Example 6, and optionally, wherein the peaks of the first antenna-pattern SL and the second antenna-pattern SL are at least 12 decibel (dB) below a peak of the antenna-pattern main beam.

Example 9 includes the subject matter of Example 6, and optionally, wherein the peaks of the first antenna-pattern SL and the second antenna-pattern SL are at least 15 decibel (dB) below a peak of the antenna-pattern main beam.

Example 10 includes the subject matter of any one of Examples 1-9, and optionally, wherein a difference between the fourth angle and the third angle is at least 50 degrees.

Example 11 includes the subject matter of any one of Examples 1-10, and optionally, wherein a difference between the fourth angle and the third angle is at least 60 degrees.

Example 12 includes the subject matter of any one of Examples 1-11, and optionally, wherein a difference between the fourth angle and the third angle is at least 70 degrees.

Example 13 includes the subject matter of any one of Examples 1-12, and optionally, wherein a difference between the fourth angle and the third angle is based on a beamwidth of a single-element beam of an antenna element of the plurality of antenna elements.

Example 14 includes the subject matter of any one of Examples 1-13, and optionally, wherein a difference between the fourth angle and the third angle is substantially equal to or greater than a beamwidth of a single-element beam of an antenna element of the plurality of antenna elements.

Example 15 includes the subject matter of any one of Examples 1-14, and optionally, wherein the predefined array factor value is at least 8 decibel (dB) below a peak of the main beam.

Example 16 includes the subject matter of any one of Examples 1-15, and optionally, wherein the predefined array factor value is at least 10 decibel (dB) below a peak of the main beam.

Example 17 includes the subject matter of any one of Examples 1-16, and optionally, wherein the predefined array factor value comprises a first array factor value, wherein the third SL peaks and the fourth SL peaks are above a second array factor value greater than the first array factor value.

Example 18 includes the subject matter of Example 17, and optionally, wherein a difference between the second array factor value and the first array factor value is at least 3 decibel (dB).

Example 19 includes the subject matter of Example 17, and optionally, wherein a difference between the second array factor value and the first array factor value is at least 4 decibel (dB).

Example 20 includes the subject matter of any one of Examples 1-19, and optionally, wherein all SLs within the first SL region and all SLs within the second SL region are below the predefined array factor value.

Example 21 includes the subject matter of any one of Examples 1-20, and optionally, wherein the main beam has a 3 decibel (dB) beamwidth of less than 10 degrees.

Example 22 includes the subject matter of any one of Examples 1-21, and optionally, wherein the main beam has a 3 decibel (dB) beamwidth of less than 7 degrees.

Example 23 includes the subject matter of any one of Examples 1-22, and optionally, wherein the main beam has a 3 decibel (dB) beamwidth of less than 5 degrees.

Example 24 includes the subject matter of any one of Examples 1-23, and optionally, wherein the main beam has a 3 decibel (dB) beamwidth of 4 degrees or less.

Example 25 includes the subject matter of any one of Examples 1-24, and optionally, wherein a difference between the sixth angle and the fifth angle is at least 160 degrees.

Example 26 includes the subject matter of any one of Examples 1-25, and optionally, wherein a difference between the sixth angle and the fifth angle is at least 170 degrees.

Example 27 includes the subject matter of any one of Examples 1-26, and optionally, wherein the RF signals comprise signals at a frequency above 70 Gigahertz (GHz).

Example 28 includes the subject matter of any one of Examples 1-27, and optionally, wherein the RF signals comprise signals in a frequency bandwidth of 76-81 Gigahertz (GHz).

Example 29 includes the subject matter of any one of Examples 1-28, and optionally, wherein the antenna array comprises a Transmit (Tx) antenna array to transmit RF Tx signals.

Example 30 includes the subject matter of Example 29, and optionally, comprising a Receive (Rx) antenna array to receive RF Rx signals based on the RF Tx signals.

Example 31 includes the subject matter of any one of Examples 1-28, and optionally, wherein the antenna array comprises a Receive (Rx) antenna array to receive RF Rx signals.

Example 32 includes the subject matter of Example 31, and optionally, comprising a Transmit (Tx) antenna array to transmit RF Tx signals, wherein the RF Rx signals are based on the RF Tx signals.

Example 33 includes the subject matter of any one of Examples 1-32, and optionally, comprising a processor to process information corresponding to the RF signals.

Example 34 includes the subject matter of any one of Examples 1-33, and optionally, comprising a processor to generate radar information based on the RF signals.

Example 35 includes the subject matter of Example 34, and optionally, comprising a vehicle, the vehicle comprising the radar device, and a system controller to control one or more systems of the vehicle based on the radar information.

Example 36 includes an antenna array according to any of Examples 1-35.

Example 37 includes a device comprising an antenna array and a communication interface to communicate signals via the antenna array according to any of Examples 1-35.

Example 38 includes a radar device comprising an antenna array according to any of Examples 1-35.

Example 39 includes a vehicle comprising an antenna array according to any of Examples 1-35.

Example 40 includes an apparatus comprising means for performing any of the described operations of any of Examples 1-35.

Example 41 includes a machine-readable medium that stores instructions for execution by a processor to perform any of the described operations of any of Examples 1-35.

Example 42 comprises a product comprising one or more tangible computer-readable non-transitory storage media comprising computer-executable instructions operable to, when executed by at least one processor, enable the at least one processor to cause a device to perform any of the described operations of any of Examples 1-35.

Example 43 includes an apparatus comprising a memory; and processing circuitry configured to perform any of the described operations of any of Examples 1-35.

Example 44 includes a method including any of the described operations of any of Examples 1-35.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1.-35. (canceled)

36. An apparatus comprising:
an antenna array comprising a plurality of antenna elements arranged according to an array arrangement configured to provide a predefined array factor comprising:
a main beam between a first angle and a second angle;
a first Side-Lobe (SL) region between the first angle and a third angle less than the first angle, wherein the first SL region comprises one or more first SL peaks below a predefined array factor value;
a second SL region between the second angle and a fourth angle larger than the second angle, wherein the second SL region comprises one or more second SL peaks below the predefined array factor value;
a third SL region between the third angle and a fifth angle less than the third angle, wherein the third SL region comprises one or more third SL peaks above the predefined array factor value; and
a fourth SL region between the fourth angle and a sixth angle larger than the fourth angle, wherein the fourth SL region comprises one or more fourth SL peaks above the predefined array factor value; and
an interface to communicate Radio Frequency (RF) signals via the antenna array.

37. The apparatus of claim 36, wherein the plurality of antenna elements comprises:
a first group of antenna elements arranged according to a uniform arrangement comprising a uniform spacing between antenna elements of the first group of antenna elements; and
a second group of antenna elements arranged according to a non-uniform arrangement comprising a non-uniform spacing between antenna elements of the second group of antenna elements.

38. The apparatus of claim 37, wherein the second group of antenna elements comprises at least 35 percent of the plurality of antenna elements.

39. The apparatus of claim 36, wherein an array pattern of the antenna array comprises:
an antenna-pattern main beam;
a first antenna-pattern SL adjacent to a first side of the antenna-pattern main beam, the first antenna-pattern SL in the first SL region; and
a second antenna-pattern SL adjacent to a second side of the antenna-pattern main beam, the second antenna-pattern SL in the second SL region,
wherein peaks of the first antenna-pattern SL and the second antenna-pattern SL are higher than any other SLs in the antenna pattern.

40. The apparatus of claim 39, wherein the peaks of the first antenna-pattern SL and the second antenna-pattern SL are at least 10 decibel (dB) below a peak of the antenna-pattern main beam.

41. The apparatus of claim 36, wherein a difference between the fourth angle and the third angle is at least 50 degrees.

42. The apparatus of claim 36, wherein a difference between the fourth angle and the third angle is based on a beamwidth of a single-element beam of an antenna element of the plurality of antenna elements.

43. The apparatus of claim 36, wherein a difference between the fourth angle and the third angle is substantially equal to or greater than a beamwidth of a single-element beam of an antenna element of the plurality of antenna elements.

44. The apparatus of claim 36, wherein the predefined array factor value is at least 8 decibel (dB) below a peak of the main beam.

45. The apparatus of claim 36, wherein the predefined array factor value comprises a first array factor value, wherein the third SL peaks and the fourth SL peaks are above a second array factor value greater than the first array factor value.

46. The apparatus of claim 45, wherein a difference between the second array factor value and the first array factor value is at least 3 decibel (dB).

47. The apparatus of claim 36, wherein all SLs within the first SL region and all SLs within the second SL region are below the predefined array factor value.

48. The apparatus of claim 36, wherein the main beam has a 3 decibel (dB) beamwidth of less than 10 degrees.

49. The apparatus of claim 36, wherein the main beam has a 3 decibel (dB) beamwidth of 4 degrees or less.

50. The apparatus of claim 36, wherein a difference between the sixth angle and the fifth angle is at least 160 degrees.

51. The apparatus of claim 36, wherein the RF signals comprise signals at a frequency above 70 Gigahertz (GHz).

52. A radar system comprising:
one or more Transmit (Tx) antennas and one or more Receive (Rx) antennas, wherein at least one of the one or more Tx antennas or the one or more Rx antennas comprises an antenna array comprising a plurality of antenna elements arranged according to an array arrangement configured to provide a predefined array factor comprising:
a main beam between a first angle and a second angle;
a first Side-Lobe (SL) region between the first angle and a third angle less than the first angle, wherein the first SL region comprises one or more first SL peaks below a predefined array factor value;
a second SL region between the second angle and a fourth angle larger than the second angle, wherein the second SL region comprises one or more second SL peaks below the predefined array factor value;
a third SL region between the third angle and a fifth angle less than the third angle, wherein the third SL region comprises one or more third SL peaks above the predefined array factor value; and
a fourth SL region between the fourth angle and a sixth angle larger than the fourth angle, wherein the fourth SL region comprises one or more fourth SL peaks above the predefined array factor value; and
a processor to generate radar information based on radar Rx signals received by the one or more Rx antennas based on one or more radar Tx signals transmitted by the one or more Tx antennas.

53. The radar system of claim 52, wherein the plurality of antenna elements comprises:
a first group of antenna elements arranged according to a uniform arrangement comprising a uniform spacing between antenna elements of the first group of antenna elements; and
a second group of antenna elements arranged according to a non-uniform arrangement comprising a non-uniform spacing between antenna elements of the second group of antenna elements.

54. A vehicle comprising:
a system controller configured to control one or more vehicular systems of the vehicle based on radar information; and
a radar system configured to provide the radar information to the system controller, the radar system comprising:
one or more Transmit (Tx) antennas and one or more Receive (Rx) antennas, wherein at least one of the one or more Tx antennas or the one or more Rx antennas comprises an antenna array comprising a plurality of antenna elements arranged according to an array arrangement configured to provide a predefined array factor comprising:
a main beam between a first angle and a second angle;
a first Side-Lobe (SL) region between the first angle and a third angle less than the first angle, wherein the first SL region comprises one or more first SL peaks below a predefined array factor value;
a second SL region between the second angle and a fourth angle larger than the second angle, wherein the second SL region comprises one or more second SL peaks below the predefined array factor value;
a third SL region between the third angle and a fifth angle less than the third angle, wherein the third SL region comprises one or more third SL peaks above the predefined array factor value; and
a fourth SL region between the fourth angle and a sixth angle larger than the fourth angle, wherein the fourth SL region comprises one or more fourth SL peaks above the predefined array factor value; and
a processor to generate the radar information based on radar Rx signals received by the one or more Rx antennas based on one or more radar Tx signals transmitted by the one or more Tx antennas.

55. The vehicle of claim 54, wherein an array pattern of the antenna array comprises:
an antenna-pattern main beam;
a first antenna-pattern SL adjacent to a first side of the antenna-pattern main beam, the first antenna-pattern SL in the first SL region; and
a second antenna-pattern SL adjacent to a second side of the antenna-pattern main beam, the second antenna-pattern SL in the second SL region,
wherein peaks of the first antenna-pattern SL and the second antenna-pattern SL are higher than any other SLs in the antenna pattern.
